(19) United States
(12) Patent Application Publication
(10) Pub. No.: US 2026/0299813 A1
(43) Pub. Date: Oct. 1, 2026

(54) REGIONAL REDUNDANCY FOR DATA STREAMING PLATFORMS

(71) Applicant: Wells Fargo Bank, N.A., San Francisco, CA (US)

(72) Inventor: Saied Saadat, Chelmsford, MA (US)

(21) Appl. No.: 19/094,513

(22) Filed: Mar. 28, 2025

(51) Int. Cl. G06F 3/06

(52) U.S. Cl. CPC G06F 3/065; G06F 3/0619

(57) ABSTRACT

Techniques are described for a complete disaster recovery solution for data streaming platforms that provides regional redundancy using a data replication mode dynamically determined for each application to balance cost and recovery objectives. The techniques determine a data replication mode to use for an application of a plurality of applications that uses a data streaming platform to publish data of the application in a primary management container within a primary region of two or more geographic regions, and replicate the data of the application captured from the primary management container within the primary region to a secondary management container within a secondary region of the two or more geographic regions using the data replication mode determined for the application. The data replication modes may include an inline replication mode and an on-demand replication mode, both of which replicate data asynchronously from a primary region to a secondary region.

### TECHNICAL FIELD

This disclosure relates to computer networks, and more specifically, to management of data replication within a network.

### BACKGROUND

Enterprise networks, especially large enterprise networks, host many different types of applications, systems, and data sources that continuously emit messages, records, or data, i.e., streaming data. Organizations may feed the streaming data into data streaming platforms configured to manage storage and/or produce real-time analytics and responses. For example, financial institutions may use streaming data to track real-time changes in the stock market, compute value at risk, automatically rebalance portfolios based on stock price movements, perform fraud detection on credit card transactions, or the like. Data streaming platforms generally ingest a data stream and incrementally update metrics, reports, and summary statistics in response to each arriving data record in the stream.

### SUMMARY

This disclosure describes techniques for a complete disaster recovery solution for data streaming platforms that provides regional redundancy using a data replication mode dynamically determined for each application to balance cost and recovery objectives. The data replication modes may include an inline replication mode and an on-demand replication mode, both of which replicate data asynchronously from a primary management container within a primary region to a secondary management container within a secondary region. The inline replication mode continuously loads batches of data replicated from the primary management container onto the secondary management container. The on-demand replication mode holds the batches of data replicated from the primary management container until a failover of the primary region and then loads batches of data within a retention period onto the secondary management container. To dynamically determine which data replication mode to use for an application, the disclosed techniques determine whether a recovery time for the primary management container provided by the on-demand replication mode satisfies a recovery objective for the application. If the recovery time provided by the on-demand replication mode does not satisfy the recovery objective for the application, the inline replication mode is selected for the application.

The disclosed techniques provide reliable backup and recovery plans for applications that use a data streaming platform to manage storage and processing of steaming data emitted by the applications where the plans are tailored for each application to satisfy recovery objectives while reducing cost where possible. The dynamic determination of data replication modes for applications ensures that applications with even the most stringent recovery objectives will be assigned an appropriate data recovery mode capable of satisfying the recovery objectives in the most cost-effective manner.

Although primarily described herein as an external solution that is implemented at a higher level than a data streaming platform, in other examples the disclosed techniques may be implemented within the data streaming platform itself. The external solution may provide more transparency for organizations to set and manage the cost and recovery objectives for different organization-specific applications, which are used by the disclosed techniques to determine the data replication mode best suited for each of the organization-specific applications.

In one example, this disclosure is directed to a computing system comprising a storage device, and processing circuitry having access to the storage device. The processing circuitry is configured to determine a data replication mode to use for an application of a plurality of applications that uses a data streaming platform to publish data of the application in a primary management container within a primary region of two or more geographic regions, and replicate the data of the application captured from the primary management container within the primary region to a secondary management container within a secondary region of the two or more geographic regions using the data replication mode determined for the application.

In another example, this disclosure is directed to a method comprising determining, by a computing system, a data replication mode to use for an application of a plurality of applications that uses a data streaming platform to publish data of the application in a primary management container within a primary region of two or more geographic regions, and replicating, by the computing system, the data of the application captured from the primary management container within the primary region to a secondary management container within a secondary region of the two or more geographic regions using the data replication mode determined for the application.

In a further example, this disclosure is directed to computer-readable media storing instructions that, when executed, cause one or more processors to determine a data replication mode to use for an application of a plurality of applications that uses a data streaming platform to publish data of the application in a primary management container within a primary region of two or more geographic regions, and replicate the data of the application captured from the primary management container within the primary region to a secondary management container within a secondary region of the two or more geographic regions using the data replication mode determined for the application.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example network system including an enterprise network, a data streaming platform, and a region redundancy system, in accordance with one or more aspects of the present disclosure.

FIG. 2 is a conceptual diagram illustrating data replication between paired regions of a data streaming platform, in accordance with one or more aspects of the present disclosure.

FIG. 3 is a block diagram illustrating an example computing system executing a region redundancy system, in accordance with one or more aspects of the present disclosure.

FIG. 4 is a flow diagram illustrating an example operation of performing data replication between paired regions of a data streaming platform, in accordance with one or more aspects of the present disclosure.

### DETAILED DESCRIPTION

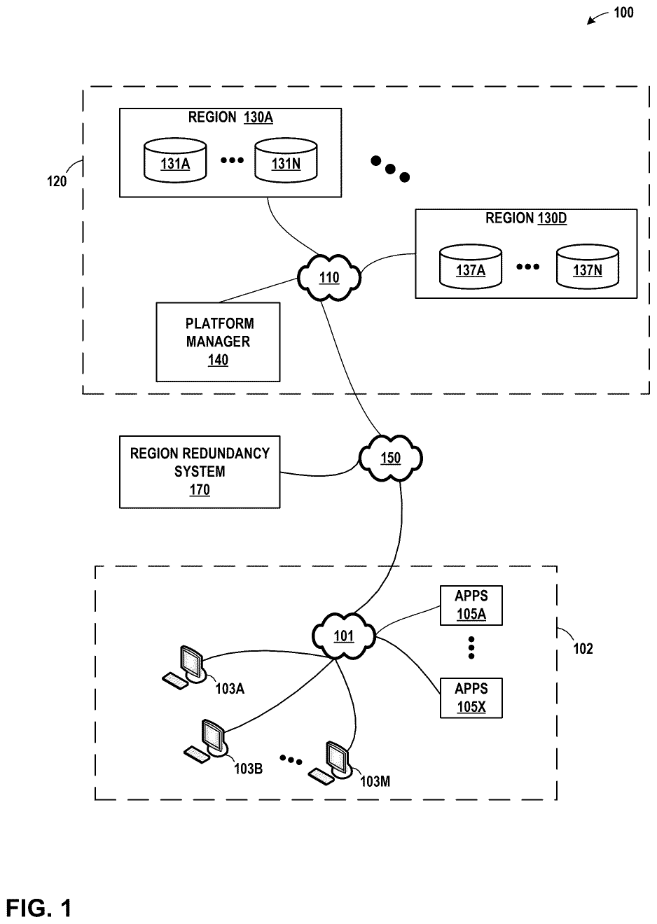

FIG. 1 is a conceptual diagram illustrating an example network system 100 including an enterprise network 102, a data streaming platform 120, and a region redundancy system 170, in accordance with one or more aspects of the present disclosure. System 100 includes three networks: private network 101, private network 110, and public network 150. Devices connected to either of private networks 101, 110 may be part of a secure network not normally accessible to the public, such as an enterprise network, organizational network, or local area network. In some examples, devices and/or computing systems on private network 101 may be considered to be on enterprise network 102, which may be controlled and/or operated by a business enterprise or other organization. Although private network 101 and/or enterprise network 102 may be principally located within one location, private network 101 and/or enterprise network 102 may also be geographically distributed across multiple locations. In another example, devices and/or computing systems on private network 110 may be considered to be part of data streaming platform 120, which may be controlled and/or operated by a data management service provider. Private network 110 and/or data streaming platform 120 are geographically distributed across multiple locations, i.e., geographical regions 130A-130D (collectively, “regions 130”).

A number of devices and/or systems are shown connected to private network 101 and part of enterprise network 102 in FIG. 1. Such devices and systems include user devices 103A, 103B, through 103M (collectively, “user devices 103”) and a plurality of applications (“apps”) 105A-105X (collectively, “applications 105”). Each of user devices 103 each may be any suitable computing device capable of being operated by a user (not shown). Such user devices 103 may include mobile devices, tablets, laptop computers, desktop computers, workstations, or any other suitable computing device. Typically, each of user devices 103 is capable of accessing other computing systems within private network 101 and outside of private network 101 (e.g., through public network 150). For instance, one or more of user devices 103 may interact with, over public network 150, one or more of data streaming platform 120 and region redundancy system 170.

One or more of applications 105 may be or include application servers and other systems that support operations and perform processing work on behalf of one or more of user devices 103. One or more of applications 105 may continuously emit data events, e.g., messages, records, or other data, pertaining to an organization or business that might use or control enterprise network 102. The continuous data sequence is referred to herein as streaming data or streaming events. In addition, one or more of applications 105 may continuously consume the events for data processing and analytics. Although illustrated in FIG. 1 as being included in enterprise network 102, i.e., on-premises, in other examples one or more of applications 105 may be cloud-based applications that may be stored in one or more data centers, such as data centers 131A-131N, 137A-137N of data streaming platform 120.

Public network 150 may be primarily described as a public network, such as the internet. However, techniques in accordance with one or more aspects of the present disclosure may apply to similar systems in which network 150 is implemented as a private network. Public network 150 may be used by user devices 103 and applications 105 within enterprise network 102 to access computing systems operated by various cloud-based service providers. Such computing systems are illustrated in FIG. 1 as data streaming platform 120. Data streaming platform 120 may be used to implement or provide an event ingestion layer for one or more applications, e.g., applications 105, as part of an event streaming solution to integrate data and analytics services. In some examples, data streaming platform 120 may comprise Event Hubs from Microsoft Azure. In other examples, data streaming platform 120 may comprise a private Kafka installation.

A number of devices and/or systems are shown connected to private network 110 and part of data streaming platform 120 in FIG. 1. Such devices and systems include a plurality of data centers within each geographic region 130A-130D across which data streaming service 120 is distributed. In the illustrated example, region 130A of data streaming service 120 includes data centers 131A-131N (collectively, “data centers 131”) and region 130D includes data centers 137A-137N (collectively, “data centers 137”). For example, data centers 131 may comprise multiple physical data center locations within the defined geographic region 130A, e.g., United States West, whereas data centers 137 may comprise multiple physical data center locations within the defined geographic region 130D, e.g., United States East. Data streaming service 120 stores data, and in some cases applications, in at least one data center in at least one region. In some scenarios, data streaming platform 120 may provide redundancy by storing data across multiple zones of data centers within a single region. In further scenarios, data streaming service 120 may provide disaster recovery between two paired regions. As described in more detail below, current disaster recovery techniques may be inadequate to achieve recovery objectives for certain sensitive applications, e.g., consumer and investment banking applications that are publishing and consuming sensitive consumer data, in a cost-effective or cost-aware manner.

Private network 110 and data streaming platform 120 also include a platform manager 140 configured to manage configuration of containers that include resources for event processing and storage on behalf of clients or organizations, e.g., client devices 103 and/or apps 105 of enterprise network 102. For example, one of client devices 103 may interact with platform manager 140 to configure at least one management container, also referred to as a “namespace,” that includes one or more event hub instances or topics. One or more of applications 105 may emit or “publish” data events for ingestion by a first event hub instance, while one or more other applications 105 may emit or “publish” data events for ingestion by a second event hub instance within the same management container or namespace. One or more of applications 105 may also consume data events from the first event hub instance and/or the second event hub instance within the management container. The management container and associated data and resources may be stored in at least one data center 131, 137 in at least one region 130.

Private networks 101, 110 may each include various other network devices, as is typical of a network. Although not shown, such devices may include one or more network hubs, network switches, network routers, satellite dishes, or any other network equipment. Such devices or components may be operatively inter-coupled, thereby providing for the exchange of information between computers, devices, or other components (e.g., between one or more client devices or systems and one or more server devices or systems). As with private networks 101, 110, public network 150 may include other network devices not specifically illustrated in FIG. 1, such as one or more network hubs, network switches, network routers, satellite dishes, or any other network equipment.

As described above, the nature of the service provided by data streaming platform 120 involves applications 105 of clients and organizations sending data to and retrieving data from data streaming platform 120. In some cases, the data provided to data streaming platform 120 includes sensitive information that is provided to data streaming platform 120 by clients having an expectation that the sensitive information will be appropriately protected against failure with little to no data loss and/or downtime. To meet recovery objectives for certain sensitive applications, e.g., consumer and investment banking applications that are publishing and consuming sensitive consumer data, a reliable backup and recovery plan needs be in place for every cloud-based service, including data streaming platform 120. Recovery objectives for applications may include recovery point objectives (RPO) and recovery time objectives (RTO). RPO requirements regulate an amount of time for which data of an application can be lost, and RTO requirements regulate an amount of time for which services of the application can be unavailable. Tier 1 or mission-critical applications have the most stringent requirements and Tier 6 or non-critical applications may have no requirements at all. In one example, for a Tier 1 application, data may be lost for up to 10 minutes, and the service may be unavailable for up to 30 minutes.

Current data streaming platforms, e.g., Azure Event Hubs, may support zone redundancy, which provides protection against failure of a data center (i.e., a zone) within a single region in which a management container or namespace is deployed. For example, when a multi-zone option is enabled for a management container within a region, all data is stored in up to three different zones or data centers within the region, which provides protection against zone failure.

Zone redundancy, however, does not protect against region failures. Failure of a region could be transient or permanent. Transient failures occur when some or all services within a region become temporarily unavailable and resume their normal operation after a short period. Data loss is possible in such cases depending on the service and its configuration. When a region becomes unavailable for an extended period, it is considered a disaster, which means, services running in that region must move to another region if they want to continue to operate. For example, to satisfy the recovery objectives for certain sensitive applications, e.g., consumer and investment banking applications, especially for Tier 1 through Tier 4, in case of a total region failure, another management container or namespace must be deployed in a second region.

In some scenarios, current data streaming platforms, e.g., Azure Event Hubs, may not support complete multi-region redundancy. In some examples, disaster recovery for management containers or namespaces may be limited to replication of configuration information. Replication of configuration information is done at the management container or namespace level and is set up by pairing a secondary region with a primary region that hosts the primary management container or namespace. Pairing a region causes all configuration information from the primary management container or namespace to be continuously replicated to the paired region. Replicated configuration information may include components like event hub instances or topics, consumer groups, and associated parameters such as number of partitions, publication rates, and retention period. In configuration-only replication scenarios, no data is replicated via this mechanism. As such, the secondary management container or namespace deployed in the secondary region contains no data (e.g., data events and checkpoints). An alias may be used to point to the primary management container or namespace in the primary region, which remains the same when the primary region fails over to the secondary region, which becomes a new primary region. Region failover may be a one-time event that can be triggered manually or automatically. Once a region fails over, the pairing between the two regions is broken. If a new backup region is desired, a new pairing must be configured. In most cases, the data from the original region can be recovered once the region becomes available after a failure, but there is no time limit for how long it may take for the region to be back online and no guarantees on availability of the data after a disaster. Thus, a complete disaster recovery solution must include not only replication of the configuration information but also of the data.

In other scenarios, current data streaming platforms, e.g., Azure Event Hubs, may support replication of both configuration information and data from a primary management container or namespace in a primary region to a secondary management container or namespace in a secondary region. This mechanism provides synchronous or asynchronous byte-to-byte replication of configuration information, data events, and consumer offsets or checkpoints. When a failover is performed, the secondary region becomes the primary region, and the previous primary region becomes the secondary. As such, current data streaming platforms may provide support for disaster recovery, but the current disaster recovery techniques, e.g., synchronous or asynchronous, are manually set during configuration at the management container or namespace level. In addition, the current disaster recovery techniques are implemented within the data streaming platform itself and tied to pricing tiers such that organizations or clients may be unable to manage costs and recovery objectives at an application level.

In accordance with the disclosed techniques, region redundancy system 170 provides a complete disaster recovery solution for data streaming platform 120 that provides regional redundancy using a data replication mode dynamically determined for each of applications 105 to balance cost and recovery objectives. In the example of FIG. 1, region redundancy system 170 comprises a cloud-based system external to and implemented at a higher level than data streaming platform 120. User devices 103 and/or application 105 within enterprise network 102 may access region redundancy system 170 via public network 150. In other examples, region redundancy system 170 may be implemented within enterprise network 102 or within data streaming platform 120.

Data steaming platform 120 and/or region redundancy system 170 may replicate configuration information for a primary management container or namespace within a primary region, e.g., region 130A, to another region, e.g., region 130D, by pairing secondary region 130D with primary region 130A that hosts the primary management container or namespace. All configuration changes made to the primary namespace are automatically copied and applied to the secondary namespace. Configuration changes include adding or deleting a topic or event hub and consumer group, or modifying associated parameters such as number of partitions, publication rates, and retention period.

As disclosed herein, region redundancy system 170 further replicates all data, e.g., data events and checkpoints, from the primary management container or namespace within primary region 130A to secondary region 130D so that the data can be recovered when primary region 130A fails. More specifically, region redundancy system 170 is configured to determine a data replication mode to use for an application, e.g., application 105A, that uses data streaming platform 120 to publish data of application 105A in the primary management container within primary region 130A. Region redundancy system 170 is further configured to replicate the data of application 105A captured from the primary management container within primary region 130A to a secondary management container within secondary region 130D using the data replication mode determined for application 105A.

The data replication modes may include an inline replication mode and an on-demand replication mode, both of which replicate data asynchronously from the primary management container within primary region 130A to the secondary management container within secondary region 130D. In either mode, the data may be captured from the primary management container and stored in a storage account, which may reside in secondary region 130D or may reside in another location remote to secondary region 130.

The inline replication mode continuously loads batches of data replicated from the storage account onto the secondary management container within secondary region 130D. As data events are produced for each topic or event hub of the primary management container, data steaming platform 120 and/or region redundancy system 170 captures the data for storage and sends the data to secondary region 130D in batches. Once a batch arrives to secondary region 130D, the data events from the batch are loaded onto a corresponding topic or event hub of the secondary management container in secondary region 130D. With the inline replication mode, secondary region 130D may be behind primary region 130A in terms of data. The lag time and/or the maximum amount of data for which secondary region 130D can fall behind primary region 130A may be controlled by modifying a batching time window and/or a batch size. The content and the size of each batch is determined by a length of time for which data is written to the batch, and a maximum amount of data that a single batch can contain. The data and time lag between secondary region 130D and primary region 130A may be reduced by shortening the batching time window and/or reducing the batch size. The lag can never be reduced to zero. With the inline replication mode, topics or event hubs in the secondary management container within secondary region 130D are operational and always ready for failover from primary region 130A.

The on-demand replication mode holds the batches of data replicated from the storage account until a failover of primary region 130A and then loads batches of data within a retention period onto the secondary management container within secondary region 130D. As described above with respect to the inline replication mode, data steaming platform 120 and/or region redundancy system 170 captures the data from primary region 130A in batches for storage and sends the data to secondary region 130D for safekeeping, except that the data is not loaded onto topics or event hubs in secondary region 130D continuously. Instead, the loading of the data from the batches onto corresponding topics or event hubs of the secondary management container in secondary region 130D is delayed until primary region 130A fails. Topics or event hubs are loaded from the batches when the failover process is initiated. Since topics or event hubs in secondary region 130D are not written to prior to failure of primary region 130A, no ingress capacity is used, which results in significant cost savings.

Implementation costs of the inline replication mode may be slightly higher than the on-demand replication mode due to the additional functionality that is needed with regards to checkpoint mapping. With regards to risk, the inline replication mode may have slightly lower risk than the on-demand replication mode because the on-demand replication mode may be operationally more complex.

The two core factors in selecting between the two replication modes for an application, e.g., application 105A, may be infrastructure cost and recovery objectives. The inline replication mode has a higher infrastructure cost than the on-demand replication mode due to its continuous use of ingress capacity to load the data onto the secondary management container. On the other hand, the on-demand replication mode may have higher latency than the inline replication mode due to its need to load all data within the retention period only after failure of primary region 130A. As such, the inline replication mode is capable of satisfying stricter recovery objectives than the on-demand replication mode because, in the on-demand replication mode, data events start being loaded to the topics or event hubs of the secondary region only after the failover process of the primary region is triggered. The time it takes to load all the topics or event hubs in the secondary management container or namespace within secondary region 130D depends on several factors, including the amount of data for each event hub, number of partitions for each event hub, and a retention period. Due to limitations of total ingress rate, the rate at which data events can be loaded to each event hub is capped. That means, a minimum amount of time is required for completing the loading process for each event hub. If this minimum exceeds the recovery objective of application 105A, then the on-demand replication mode is not an option for the application and the inline replication mode will instead be selected.

To dynamically determine which data replication mode to use for an application, region redundancy system 170 may determine whether a recovery time for the primary management container provided by the on-demand replication mode satisfies a recovery objective for application 105A. If the recovery time provided by the on-demand replication mode does not satisfy the recovery objective for application 105A, the inline replication mode is selected for application 105A.

The disclosed techniques provide reliable backup and recovery plans for applications that use a data streaming platform to manage storage and processing of steaming data emitted by the applications where the plans are tailored for each application to satisfy recovery objectives while reducing cost where possible. The dynamic determination of data replication modes for applications ensures that applications with even the most stringent recovery objectives will be assigned an appropriate data recovery mode capable of satisfying the recovery objectives in the most cost-effective manner.

Although primarily described herein as an external solution that is implemented at a higher level than data streaming platform 120, in other examples region redundancy system 170 may be implemented within data streaming platform 120 itself. The external solution, however, may provide more transparency for organizations to set and manage the cost and recovery objectives for different organization-specific applications, which are used by the disclosed techniques to determine the data replication mode best suited for each of the organization-specific applications.

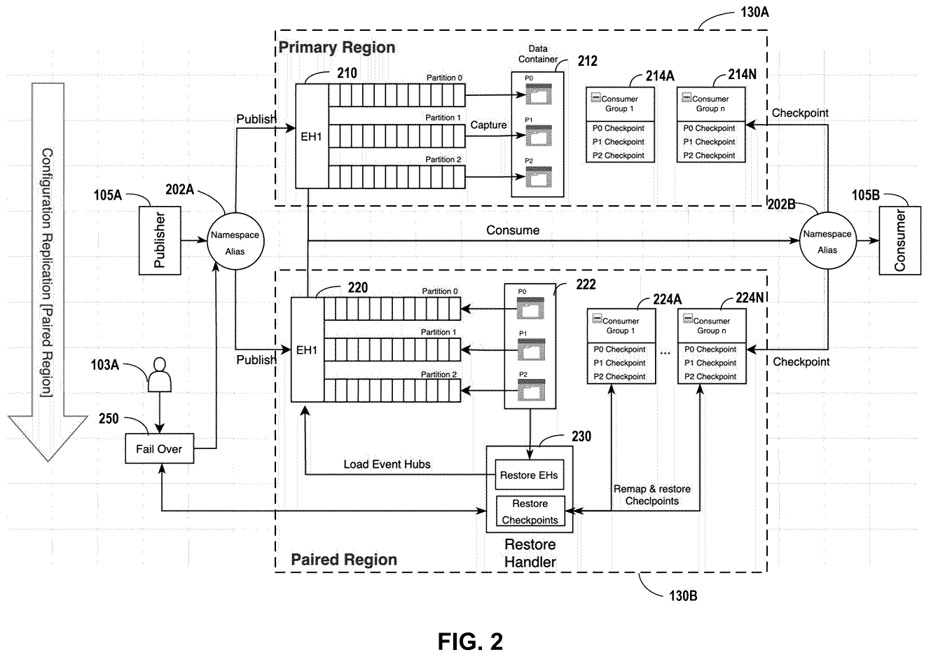

FIG. 2 is a conceptual diagram illustrating data replication between paired regions 130A, 130B of a data streaming platform, e.g., data streaming platform 120 of FIG. 1, in accordance with one or more aspects of the present disclosure. FIG. 2 includes a publisher application 105A and a consumer application 105B, user device 103A, and namespace alias 202A and 202B (collectively, “namespace aliases 202”) interacting with the data streaming platform. Primary region 130A includes a primary management container or namespace 210 having a single topic or event hub (EH1) with multiple partitions, data container 212, and consumer group checkpoints 214A-214N (collectively, “consumer group checkpoints 214”). Secondary region 130D is paired with primary region 130A and includes a corresponding secondary management container or namespace 220 having a single topic or event hub (EH1) with multiple partitions, data container 222, consumer group checkpoints 224A-224N (collectively, “consumer group checkpoints 224”), and restore handler 230.

The diagram of FIG. 2 illustrates the process through which data is replicated from primary management container 210 in primary region 130A to secondary management container 220 in secondary region 130B. Although illustrated in FIG. 1 as replication data for a single topic or event hub (EH1) for clarity, there is no limitation on the number of topics or event hubs that can be replicated as described herein.

The data streaming platform of FIG. 2 may comprise Event Hubs from Microsoft Azure or, in other examples, a private Kafka installation. Some of the terms used herein, and defined here, are applicable to Azure Event Hubs, but the same or similar terminology is applicable to the Kafka installation or other data streaming platforms and should not be interpreted as limiting.

Publisher 105A is a program or application that sends events to a partition of a topic or event hub. Consumer 105B is a program or application that consumes events from one or more partitions of a topic or event hub. A partition is a stream in a topic or event hub that holds data events in the order in which the data events are published. A consumer group is a group of consumers that together, in coordination with each other, consume messages from an event hub. An enqueued timestamp is the time at which a message is written to a partition. An offset is a marker that indicates the location of the first byte of a message in a partition. A sequence is a marker that indicates the location of a message in a partition relative to other messages in the same partition. A checkpoint is a marker that indicates the last message that was consumed from a partition and processed by a consumer group. A storage container is a logical location in a storage account that can store data files.

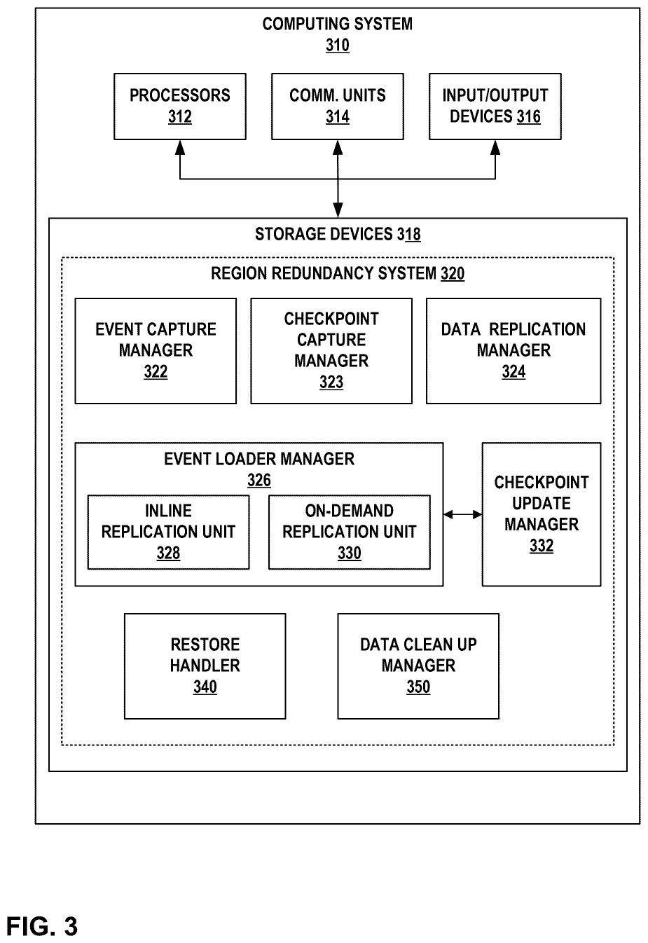

The diagram of FIG. 2 illustrates one event hub (EH1) that has three partitions in a primary management container or namespace 210 within primary region 130A. The following description sets forth steps that are taken to complete replication of data from primary management container 210 in primary region 130A to secondary management container 220 in secondary region 130B. The process steps are likewise applicable to every topic or event hub in primary management container or namespace 210 independently. In some examples, the process steps of FIG. 2 may be performed by region redundancy system 170 from FIG. 1 or a computing system 310 executing a region redundancy system 320 from FIG. 3. For purposes of illustration, the process steps are described herein as being performed by region redundancy system 320 from FIG. 3.

As a first step, either the data streaming platform itself, e.g., Azure Event Hubs, or event capture manager 322 of region redundancy system 320 may capture all events that are published in the primary namespace 221 of primary region 130A. Data events are captured and stored independently for each partition of each event hub, so they can be restored in the same way in the secondary namespace 220 of secondary region 130B. The capture process may be configured to collect, batch, and store data events as the data events are published into each partition of each event hub on primary namespace 221. Batching of events is controlled by a batching time window and/or a maximum batch size. Events from each partition are collected, batched, and then saved when the specified batching time window expires or the specified maximum batch size for the batch is reached. Each batch is saved as a data file in a directory or storage account, e.g., data container 212, based on the configured structure for each event hub. The name of the event hub, partition number, and the capture time can be part of the directory structure, which makes it easier to later locate batches containing events for a certain period. In addition to the payload, the sequence number and the offset of the event in the partition, along with the event's enqueued timestamp, are stored in the batch for each event.

Checkpoints are created and maintained by the consuming application 105B. Each consuming application 105B is responsible for checkpointing each of the consumer groups that it manages by periodically writing the last event that they have consumed and processed from each partition. Either the data streaming platform itself, e.g., Azure Event Hubs, or checkpoint capture manager 323 of region redundancy system 320 may capture and store checkpoints in a container in a storage account, one for each partition in each event hub, for each consumer group, for example consumer group checkpoints 214 in primary region 130A and consumer group checkpoints 224 of secondary region 130B. For performance reasons, some applications may choose not to update their checkpoints for every event they consume and process but instead may update their checkpoints periodically or for multiple events, for instance, every one minute or for every 20 events. If consuming application 105B consumes and processes some events and crashes before getting a chance to update its checkpoints in its consumer group checkpoints 214, the next consumer from the same consumer group will receive those messages that the previous application had processed before crashing. Applications, therefore, must be able to deal with duplicate events.

Either the data streaming platform itself, e.g., Azure Event Hubs, or data replication manager 324 of region redundancy system 320 may continuously copy data, e.g., data event files and checkpoints, from the primary region 130A to the secondary region 130B. In some examples, storage account data can be copied from primary region 130A to secondary region 130B automatically using Azure's Read Access Geo-Redundant-Storage (RA-GRS) or Geo-Zone-Redundant-Storage (RA-GZRS). When using RA-GRS or RA-GZRS, each primary region is tied to a specific secondary region, which may be different from the paired, secondary region 130B of the primary namespace 210. The secondary storage account is in a read-only mode until it is failed over to, at which point it becomes fully accessible. An alternate method for moving the event and checkpoint files is using a program that looks for new files in primary region 130A and copies them over to paired, secondary region 130B.

It is also possible to have topics or event hubs of primary namespace 210 write the captured batch directly to another region. This might make the overall process simpler but makes the design vulnerable to double-region-failure since the batches would only exist in a single region. By capturing the events in primary region 130A and then copying them to another region (e.g., paired secondary region 130B or another one of regions 130), batches will always exist in two different regions.

Data events stored in the batch data files contain the payload (i.e., the original data event) and a few extra pieces of information related to the location and queuing time of the data event in the original partition in the primary namespace 210. These additional pieces of information are used for creating and updating checkpoints but must be removed from the data events before they are loaded onto the corresponding partitions in secondary namespace 220.

In accordance with the disclosed techniques, data replication manager 324 of region redundancy system 320 may determine a data replication mode to use for application 105A that publishes data of the application in the primary namespace 210 within primary region 130A, and event loader manager 326 of region redundancy system 320 may load the replicated events onto the secondary namespace 220 in two different ways: inline and on-demand, irrespective of the location and region in which event batches are stored.

For example, inline replication unit 328 may perform the inline replication mode, in which the loading of events from batches to partitions is done asynchronously and continuously. As the event data files are replicated to the storage on secondary region 130B, they are processed and the events they contain are loaded onto their respective partitions of secondary namespace 220. Since the loading process is continuous, primary region 130A might fail over to the paired, secondary region 130B at any time during the loading process. If primary region 130A fails over to secondary region 130B before the last batch of events is processed, the loading continues until all events are loaded. If a consumer application 105B connects to a partition that is still being loaded, it simply starts consuming the events that are in the partition. The consumer applicatoin 105B then receives more events, as they are loaded to the partition. However, no events must be allowed to be published to any partition that is still being loaded. If a publisher application 105A is allowed to connect to a partition that is still being loaded, an error will occur if the publisher application 105A has a checkpoint that is more recent than the last loaded event in the partition. To keep the process clean and safe, publisher applications 105 should be allowed to connect only when the loading process is complete.

If the replicated batches reside in a region that is different from the secondary region 130B hosting the secondary namespace 220, event loader manager 326 can either copy the batches to the secondary region 130B or simply read them from their original location. In either case, transmission from a remote region will add some latency to the loading operation. The latency may be lowered by copying the files asynchronously to the secondary region 130B from the remote region.

As another example, on-line replication unit 330 may perform the on-demand replication mode, in which no data events are loaded onto any partition of the secondary namespace 220 unless the failover process 250 of primary region 130A is triggered. Without a failover, all partitions of all event hubs in the secondary namespace 220 are empty. The failover process 250 invokes event loader manager 326, which extracts the events from the replicated event data files and loads them onto the appropriate partitions in the secondary namespace 220. On-demand replication unit 330 first determines the oldest event that it needs to load based on the retention period for the target event hub of the secondary namespace 220. The oldest event that needs to be loaded to an event hub is the event that has the latest “enqueued time” that is smaller than the current time minus the retention period for the event hub. Once that time is determined, on-demand replication unit 330 locates the batch file that includes the determined time and starts loading the events starting with the event whose enqueued time matches the target time. The loading continues with all newer batches.

Note that it is possible the enqueue time of the first event cannot be matched to any batch file. That could happen if there is a period in which no events were added to the partition in the primary namespace 210 and consequently no batch file was created. In such a case, on-demand replication unit 330 may start loading from the batch with a timestamp that immediately follows the targeted time. While loading events, for each partition, on-demand replication unit 330 needs to retrieve the new sequence number, offset and the enqueued time of every event after they are added and match them with the checkpoint for the partition.

Besides the difference between the inline and on-demand replication modes in terms of timing, there are other significant differences that data replication manager 324 may consider when choosing between the two modes.

For example, the inline mode has a higher cost compared to the on-demand mode. That is because the inline mode continuously uses ingress capacity for all event hubs in the namespace to load the events, for the extremely rare event of a region failure. No egress capacity is used since events are not consumed. This cost could be very significant for namespaces that have many event hubs and/or receive events at a high rate. The on-demand replication mode does not use ingress or egress capacity unless a failover occurs and, in the event of such an occurrence, it only uses as much ingress capacity as it needs to load the necessary batches only one time. The inline replication mode may add a plurality of events (e.g., tens or hundreds of events) and hundreds or thousands of dollars a year to the cost for applications that produce events at a high rate. Consider, for a reference, in a standard tier namespace, one throughput unit (TU) provides 1 MB or 1,000 messages per second of ingress capacity. If an application, for instance, produces 10 MB per second, it must allocate ten TUs for its primary namespace and another ten TUs for its secondary namespace.

As another example, once the failover is triggered, the inline replication mode requires less time, if any, to complete the loading of the events, since it should be either current or slightly behind with the processing of the batches most of the times. The on-demand replication mode, on the other hand, has to start the loading from scratch. The total time that the on-demand replication unit 330 will need to complete the process will depend on the number of event hubs and their configurations, including number of partitions, retention period, and the number of events and their payload size. The maximum ingress capacity for a namespace is determined by the purchased capacity for the namespace. For instance, for the standard tier, one TU allows a maximum of 1 MB or 1,000 messages per second (whichever is reached first) of ingress, which is 3.6 million messages or 3.6 GB per hour. The ingress capacity is shared across all event hubs and partitions within the namespace. In some examples, a maximum of 40 TUs can be allocated to a namespace, which provide a total hourly capacity of 144 GB or 144 M messages.

Suppose on average, each partition in a namespace is published to at the rate of r_{b} megabytes and rₘ messages per hour and has the retention period of hᵣ hours. Further suppose that the namespace has p partitions. The total amount of data that can ever be in the namespace is p×rₘ×hᵣ messages and p×r_{b}×hᵣ megabytes. Accordingly, the total number of hours needed for loading the batched events to the namespace is at least Tₘᵢₙ, as calculated below.

$${T}_{min} = max ( p \times {r}_{m} \times {h}_{r} / 1 \; 44 msg / hour , p \times {r}_{b} \times {h}_{r} / 144 , 000 MB / hour )$$

Assuming an x % budget for loading events during failover, the on-demand replication mode can provide the following recovery time.

$${RTO}^{′} = {T}_{min} / x \%$$

If the recovery objective for the application is stricter than the recovery time of the on-demand replication mode, the on-demand replication mode will not be able to satisfy the recovery objective for the application. For example, take application A, with the following characteristics:
Budgeted Load Time: 75%
Event Hubs Tier: Standard
Throughput Units: 40 (max)
Total number of partitions: 20
Average retention: 168 hours (7 days)
Average publishing rate: 50 message/sec
Average event size: 1.2 kb (0.0012 mb)

The minimum load time and RTO′ can be calculated as follows.

$${r}_{m} = 50 \times 3600 = 180 , 000 msg / hour$$

$${r}_{b} = 50 \times 0.0012 \times 3600 = 216 MB / hour$$

$$\begin{matrix}{T}_{min} = max ( 20 \times 180 , 000 msg / hour \times 168 hours / 144 M msg / hour , 20 \times \\ 216 MB / hour \times 168 hours / 144 , 000 MB / hour ) \\ = max ( 4.2 h , 5.04 h ) \\ = 5.04 hours\end{matrix}$$

$${RTO}^{′} = 5.04 / 75 \% = 6.72$$

Which means the on-demand replication mode could not support any application whose recovery objective is less than 6.72 hours. Such an application must use the inline replication mode.

Consumer applications 105B use checkpoints to keep track of where they are in a stream or partition with regards to processing of events. One of the very important reasons for keeping track of the last message that was received and successfully processed is for the consumer applications 105B to know from where in the stream to start reading when they reconnect to the event hub for the first time or after getting disconnected. Generally, upon connecting, consumer applications 105B read their consumer group's checkpoints for all partitions of the event hub they want to consume from and start reading the next message as indicating by the checkpoint. Checkpoints are stored in consumer group checkpoint containers 214 in primary region 130A and consumer group checkpoint containers 224 in secondary region 130B. Containers 214, 224 include one checkpoint file for each partition of an event hub for each consumer group, which gets updated every time a consumer updates its checkpoint. Checkpoint files contain, as properties, an associated data event's enqueued timestamp, sequence number, and offset. Checkpoint files have no payload.

Data replication manager 324 replicates checkpoint files to secondary region 130B in a similar fashion as event data files, but they are not usable in their original state. That is because the information they contain is not valid in secondary region 130B, since the enqueued timestamp, sequence number, and offset of the events change when they are loaded onto the event hubs in the secondary namespace 220. Checkpoint update manger 332 updates the content of each of the checkpoints stored in consumer group checkpoint containers 224 so that they refer to the same event in secondary namespace 220 as they did in primary namespace 210. For instance, an original checkpoint that contains the properties (“2024-02-05 13:08:23.234”, 23334455, 2308930840233) for enqueued timestamp, sequence number and offset, may be converted to (“2024-05-08 10:56:11.401”, 45432, 9930303209). The new checkpoint references the same event in the event hub of secondary namespace 220 within secondary region 130B as the original checkpoint refers to in the event hub of primary namespace 210 within primary region 130A. This makes it possible for the consuming applications 105B to connect to secondary region 130B after the failover process 205 is complete and resume their operations normally without having to do anything on their side to deal with checkpoints discrepancy between the regions 130A, 130B.

The way checkpoint updates are dealt with is different for each replication mode. In the on-demand replication mode, matching the checkpointed event can be done during the event loading process. Before it begins loading a partition, event loader manager 326 and/or checkpoint update manager 332 extracts the sequence number (or offset) of the partition's checkpoint. While event loader manager 326 loads the events, checkpoint update manager 332 compares each message's sequence number with the one from the checkpoint. The message whose original sequence number matches the one from the checkpoint is checkpointed for the partition in the secondary namespace 220. Checkpoint update manager 332 does this for all consumer groups for the partition that it is loading, so each consumer group is checkpointed by the end of the loading process. The matching process can stop as soon as a matching event is found for that consumer group. Matching can be done using sequence numbers or offsets but not timestamps since sequence numbers and offsets are unique for each partition, but timestamps are not.

It is possible that a checkpoint's sequence number is smaller than the checkpoint of the very first event or greater than the last event that is loaded. The first case could happen if the consumer application 105B had not consumed or checkpointed any events for longer than the retention period of the partition. In this case, the checkpoint is set to the beginning of the stream (e.g., offset 0). If the original checkpoint's offset is greater than the last message that is loaded, it means that the consumer group has already consumed all the messages in the partition. It is also possible that the consumer group has consumed more messages that were never captured or copied to the secondary region 130B. Those messages are lost. In such a case, the last message in the partition is checkpointed.

Unlike the on-demand mode, the inline replication mode cannot statically match the checkpoints while loading the events because checkpoints keep changing and may not be synchronized with the event files. In other words, the latest checkpoint for a partition for a consumer group may be pointing to an event that was in the previously loaded batch or to an event that has not yet arrived. One way to handle this is for checkpoint update manager 332 to keep a mapping of the sequence numbers of the original events to sequence number of the replicated events while the events are being loaded by event loader manager 326. Such a map will always have a limited size since it only needs to keep entries that refer to events that have sequence numbers higher than the last checkpoint. In the absolute worst case, the map will have to hold all unexpired events for the partition. The runtime of matching an old checkpoint to a message is O(1), while the memory performance of the entire operation is O(n), where n is the number of entries in the map which can be as large as the total number of events in the partition. The map may be maintained in persistent storage such that it is durable in case event loader manager 326 crashes or restarts for any reason. A storage account table may be a suitable storage for this purpose. Data clean up manager 350 may also be needed for purging table entries or mappings that are out of date and no longer needed.

Failing over from primary region 130A to secondary region 130B is a risky operation that should be handled carefully. The first step of failover process 250 is to recognize that primary region 130A has permanently failed. Once that determination is done, the failover process 250 needs to be triggered. Due to complexities involved with recognizing and then triggering the failover process 250, the failover process 250 may be triggered manually, e.g., by a user of user device 130A. Once user device 130A or another computing system ensures that primary region 130A has failed, the failover process 250 may be triggered manually to make the switch from primary region 130A to secondary region 130B. For example, the failover process 250 may include signaling applications 105 to disconnect from event hubs of primary namespace 210 in primary region 130A and prepare for failing over to secondary namespace 220 in secondary region 130B. Failover process 250 instructs restore handler 230, 340 to start the event hub restoration process in the secondary region 130B. Failover process 250 breaks the pairing between the current primary region 130A and the secondary region 130B, and promotes the secondary region 130B to become the new primary region. Failover process 250 may optionally pair the new primary region 130B with another one of regions 130. In addition, failover process 250 updates or activates endpoints of the primary namespace 210 to point to namespace 220 in secondary region 130B. Failover process 250 then instructs event loader manager 326 to stop or undeploy the event loader process. Failover process 250 signals the applications 105 to reconnect to event hubs of secondary namespace 220 in new primary region 130B. Namespace aliases 202 allows for creating an alias for a namespace endpoint, which can point to the primary and/or secondary region. Optionally, applications 105 may set up and use this alias.

Event loader manager 326 ensures that events are loaded onto their respective partitions and checkpoints are created and updated properly. The nature of the component that encapsulates and executes these operations depends on the replication mode. In the inline replication mode, event loader manager 326 may run continuously, whereas in the on-demand replication mode, event loader manager 326 may run once when the failover process 250 is triggered and exits when the operation is completed. In some examples, event loader manager 326 may comprise a container with the event loader program that can be started and stopped at any time. In the inline replication mode, such a container may be deployed and started when the secondary region 130B is set up. In the on-demand replication mode, such a container may be deployed at any time and started when the failover process 250 is triggered.

Data clean up manager 350 may periodically clean up replicated event batches and checkpoints to prevent accumulation of unnecessary or out of date files. Data clean up manager 350 may purge event files and checkpoints as soon as they become older than the retention period of the event hub to which they belong. Data clean up manager 350 may be executed for both the on-demand replication mode and the inline replication mode, although, in the inline replication mode, the deletion of event batches and checkpoints may happen as soon as they are loaded onto the secondary namespace 220.

The replication described above is asynchronous with two modes: inline and on-demand. Through that process, data events are collected from the primary management container or namespace, batched, and loaded onto the secondary management container or namespace at a later time, either shortly or long after the batches are collected. Alternatively, events can be loaded onto the secondary namespace in real time. That is, events are streamed from the partitions in the primary namespace to their corresponding partitions in the namespace in the secondary region. Synchronous data replication has the following advantages and disadvantages.

Either data streaming service 120 and/or region redundancy system 320 would need to run a program continuously to consume from all partitions of all event hubs via a dedicated consumer group and publish those events to their corresponding event hub in the secondary namespace. The program needs to be maintained and monitored to ensure that it runs at all times and does its job. As the number of event hubs, partitions, and event publishing rates increase, multiple instance of such a program may be needed.

Alternatively, the responsibility of publishing events to the primary namespace in the primary region and the secondary namespace in the secondary region is pushed up to the applications. Requiring applications to take on this responsibility adds a lot of complexity and forces the applications to deal with inconsistencies between the two namespaces, which is not an easy problem to solve. Requiring applications to take on this responsibility also creates dependencies between applications and the disaster recovery solution and requires the applications to make changes if the overall solution changes.

Real time or synchronous data replication also comes with significant additional infrastructure cost and operational cost. The infrastructure cost is for running the real time replicator programs and the operational cost is for operating and maintaining the program and related processes. The ingress cost of this solution is comparable to the inline replication mode of the asynchronous model. In addition, replicating the events synchronously does not address the checkpoint inconsistency issue. Checkpoints must be transferred to and then transformed in the secondary region, which will require all the file transfer and transformation processes that the inline replication mode of the asynchronous method requires.

Even further, because event data are not captured or persisted anywhere else than event hubs, if and/or when either the primary or secondary region fails, the only source of data is the event hubs themselves. To create a new secondary region, the event data must be reread and re-streamed onto the new secondary region. The replicator process must support rereading and streaming the data to a new region, which introduces additional complexity. In comparison, in the asynchronous replication modes, event data are stored in data files, which are portable to any system for any reason. Reloading them onto a new region will not affect the source region.

FIG. 3 is a block diagram illustrating an example computing system 310 executing a region redundancy system 320, in accordance with one or more aspects of the present disclosure. Computing system 310 may generally correspond to a device that includes and/or implements aspects of the functionality of region redundancy system 170 illustrated in FIG. 1. Accordingly, computing system 310 may perform some or all of the same functions described in connection with FIG. 1 as being performed by region redundancy system 170 with respect to data streaming platform 120.

Computing system 310 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 310 represents a cloud computing system, server farm, and/or server cluster (or portion thereof) that provides services to client devices and other devices or systems.

Although computing system 310 of FIG. 3 is illustrated as a stand-alone device, in other examples computing system 310 may be implemented in any of a wide variety of ways and may be implemented using multiple devices and/or systems. In some examples, computing system 310 may be, or may be part of, any component, device, or system that includes a processor or other suitable computing environment for processing information or executing software instructions and that operates in accordance with one or more aspects of the present disclosure. In some examples, computing system 310 may be fully implemented as hardware in one or more devices or logic elements.

In the example of FIG. 3, computing system 310 may include one or more processors 312, one or more communication units 314, one or more input/output devices 316, and one or more storage devices 318. Storage devices 318 includes region redundancy system 320, which may operate substantially similar to region redundancy system 170 from FIG. 1. Event loader manager 326 may further include an inline replication unit 328 and an on-demand replication unit 330. One or more of the devices, modules, storage areas, or other components of computing system 310 may be interconnected to enable inter-component communications (physically, communicatively, and/or operatively). In some examples, such connectivity may be provided by through communication channels, a system bus, a network connection, an inter-process communication data structure, or any other method for communicating data. A power source (not shown) provides power to one or more components of computing system 310. In some examples, the power source may receive power from the primary alternative current (AC) power supply in a commercial building or data center, where some or all of an enterprise network may reside. In other examples, the power source may be or may include a battery.

One or more processors 312 of computing system 310 may implement functionality and/or execute instructions associated with computing system 310 associated with one or more modules illustrated herein and/or described below. One or more processors 312 may be, may be part of, and/or may include processing circuitry that performs operations in accordance with one or more aspects of the present disclosure. Examples of processors 312 include microprocessors, application processors, display controllers, auxiliary processors, one or more sensor hubs, and any other hardware configured to function as a processor, a processing unit, or a processing device. Computing system 310 may use one or more processors 312 to perform operations in accordance with one or more aspects of the present disclosure using software, hardware, firmware, or a mixture of hardware, software, and firmware residing in and/or executing at computing system 310.

One or more communication units 314 of computing system 310 may communicate with devices external to computing system 310 by transmitting and/or receiving data, and may operate, in some respects, as both an input device and an output device. In some examples, communication units 314 may communicate with other devices over a network. In other examples, communication units 314 may send and/or receive radio signals on a radio network such as a cellular radio network. In other examples, communication units 314 of computing system 310 may transmit and/or receive satellite signals on a satellite network such as a Global Positioning System (GPS) network. Examples of communication units 314 include a network interface card (e.g., such as an Ethernet card), an optical transceiver, a radio frequency transceiver, a GPS receiver, or any other type of device that can send and/or receive information. Other examples of communication units 314 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input/output devices 316 may represent any input or output devices of computing system 310 not otherwise separately described herein. One or more input/output devices 316 may generate, receive, and/or process input from any type of device capable of detecting input from a human or machine. One or more input/output devices 316 may generate, present, and/or process output through any type of device capable of producing output.

One or more storage devices 318 within computing system 310 may store information for processing during operation of computing system 310. Storage devices 318 may store program instructions and/or data associated with one or more of the modules described in accordance with one or more aspects of this disclosure. One or more processors 312 and one or more storage devices 318 may provide an operating environment or platform for such modules, which may be implemented as software, but may in some examples include any combination of hardware, firmware, and software. One or more processors 312 may execute instructions and one or more storage devices 318 may store instructions and/or data of one or more modules. The combination of processors 312 and storage devices 318 may retrieve, store, and/or execute the instructions and/or data of one or more applications, modules, or software. Processors 312 and/or storage devices 318 may also be operably coupled to one or more other software and/or hardware components, including, but not limited to, one or more of the components of computing system 310 and/or one or more devices or systems illustrated as being connected to computing system 310.

In some examples, one or more storage devices 318 are temporary memories, meaning that a primary purpose of the one or more storage devices is not long-term storage. Storage devices 318 of computing system 310 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 318, in some examples, also include one or more computer-readable storage media. Storage devices 318 may be configured to store larger amounts of information than volatile memory. Storage devices 318 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

In the example of FIG. 3, region redundancy system 320 includes event capture manager 322, checkpoint capture manager 323, data replication manager 324, event loader manager 326, checkpoint update manager 332, restore handler 340, and data clean up manager 350. Event loader manager 326 may further include an inline replication unit 328 and an on-demand replication unit 330. The components of region redundancy system 320 may operate as described above with respect to the data replication process illustrated in FIG. 2.

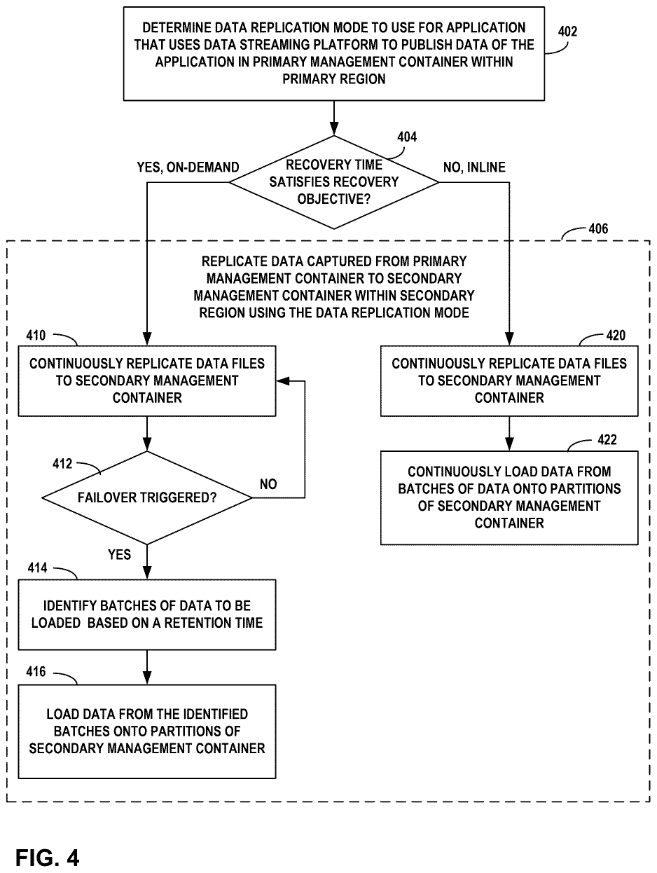

FIG. 4 is a flow diagram illustrating an example operation of performing data replication between paired regions of a data streaming platform, in accordance with one or more aspects of the present disclosure. The example operation illustrated in FIG. 4 is described with respect to region redundancy system 170 of FIG. 1. In other examples, the operations illustrated in FIG. 4 may be performed by computing system 310 executing region redundancy system 320 of FIG. 3, platform manager 140 within data streaming platform 120 of FIG. 1, or one or more other components, modules, systems, or devices. Further, in other examples, operations described in connection with FIG. 4 may be merged, performed in a difference sequence, or omitted.

Region redundancy system 170 determines a data replication mode to use for an application, e.g., application 105A, of a plurality of applications 105 that uses data streaming platform 120 to publish data of application 105A in a primary management container within a primary region, e.g., region 130A, of two or more geographic regions 130 (402). The data replication mode for application 105A may be one of an inline replication mode or an on-demand replication mode, both of which replicate data asynchronously from the primary management container within primary region 130A to a secondary management container within a secondary region, e.g., region 130D.

To determine the data replication mode for application 105A, region redundancy system 170 determines whether a recovery time for the primary management container provided by the on-demand replication mode satisfies a recovery objective for application 105A (404). The recovery time for the primary management container comprises a minimum amount of time required to load the data of application 105A from a storage account onto one or more partitions of the secondary management container within secondary region 130D. Region redundancy system may determine the recovery time for the primary management container based on a number of partitions of the primary management container, a publication rate to each partition of the primary management container, a retention period for the primary management container, and a budgeted load time during failover from the primary management container within primary region 130A to the secondary management container within secondary region 130D.

Based on the recovery time for the primary management container satisfying the recovery objective for application 105A, region redundancy system 170 determines that the data replication mode for application 105A comprises the on-demand replication mode (YES branch of 404). Based on the recovery time for the primary management container not satisfying the recovery objective for application 105A, region redundancy system 170 determines that the data replication mode for application 105A comprises an inline replication mode (NO branch of 404).

Region redundancy system 170 then replicates the data of application 105A captured from the primary management container within primary region 130A to a secondary management container within secondary region 130D of the two or more geographic regions 130 using the data replication mode determined for application 105A (406).

In some examples, data streaming platform 120 and/or region redundancy system 170 “pairs” primary region 130A with secondary region 130D to manage replication of configuration information for the primary management container within primary region 130A to the secondary management container within secondary region 130D. In some examples, data streaming platform 120 automatically replicates the configuration information based on the pairing. In other examples, region redundancy system 170 is configured to perform the continuous replication of the configuration information. The configuration information for the primary management container may include topics or event hubs, consumer groups, and associated parameters such as number of partitions, publication rates, and retention period.

Data streaming platform 120 and/or region redundancy system 170 captures the data of application 105A from one or more partitions of the primary management container in primary region 130A for storage in batches for the one or more partitions as a plurality of data files in a storage account. In some examples, data streaming platform 120 may automatically perform the capture process. In other examples, region redundancy system 170 performs the capture process, which includes collecting data published to each partition of the one or more partitions of the primary management container in one or more batches according to at least one of a time window or a maximum batch size and storing the batches for the one or more partitions as the plurality of data files in the storage account.

When the on-demand replication mode is selected for application 105A (YES branch of 404), region redundancy system 170 continuously replicates the plurality of data files from the storage account to the secondary management container within secondary region 130D (410). Based on a failover from primary region 130A to secondary region 130D being triggered (YES branch of 412), region redundancy system 170 identifies one or more batches included in the replicated data files to be loaded onto a partition of the secondary management container based on a retention period for the primary management container (414). Region redundancy system 170 then loads the data from the one or more batches included in the replicated data files onto one or more partitions of the secondary management container within secondary region 130D (416).

The data of application 105A may include both data events or messages and checkpoints indicating a last message consumed from a partition of the primary management container and processed by one of the consumer groups. To manage the checkpoints for the on-demand replication mode, region redundancy system 170 may extract a sequence number of a checkpoint for each partition of the primary management container, and compare the sequence number of the checkpoint with an original sequence number of each replicated data event being loaded onto each partition of the secondary management container to determine which data event of the replicated data events is checkpointed for each partition of the secondary management container.

When the inline replication mode is selected for application 105A (NO branch of 404), region redundancy system 170 continuously replicates the plurality of data files from the storage account to the secondary management container within secondary region 130D (420) and continuously loads the data from the batches included in the replicated data files onto one or more partitions of the secondary management container within secondary region 130D (422). To manage the checkpoints for the inline replication mode, region redundancy system 170 may maintain a mapping of sequence numbers of original data events within each partition of the primary management container to sequence numbers of replicated data events within each partition of the secondary management container, and based on the mapping, determine which data event of the replicated data events is checkpointed for each partition of the secondary management container.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of computer program from one place to another, e.g., according to a communication protocol. In this manner, computer-readable storage media generally may correspond to (1) tangible computer-readable storage media which is non-transitory or (2) a communication media such as signal or carrier wave. Data storage media may be any available media that can be accessed by one or more computers or one or more processing circuits to receive instructs, code and/or data structures for implementation of the techniques described in this disclosure. A computer program product may include a computer-readable medium.

By way of example and not limitation, such computer-readable storage media may include RAM, ROM, EEPROM, CD-ROM, or other optical disk storage, magnetic disk storage, or other magnetic storage devices, flash memory, cache memory, or any other medium that can be used to store desired program code in the form of instructions or store data structures and that can be access by a computer. Also, any connection is a properly termed a computer-readable medium. For example, if instructions are transmitted from a website, server, or other remote source using a coaxial cable, fiber optic cable, twisted pair, digital subscriber line (DSL), or other wireless technologies such as infrared, radio, and microwave, then the coaxial cable, fiber optic cable, twisted pair, DSL, or other wireless technologies such as infrared, radio, and microwave are included in the definition of medium. It should be understood, however, that computer-readable storage media and data storage media do not include connections, carrier waves, signals, or other transient media, but are directed to non-transient, tangible storage media. Disk and disc, as used herein, includes compact disk (CD), laser disc, optical disc, digital versatile disc (DVD), and Blu-ray disc, where disks usually reproduce data magnetically, while discs reproduce data optically with lasers. Combinations of the above should be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure of any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, software systems, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A computing system comprising:
a storage device; and
processing circuitry having access to the storage device and configured to:
determine a data replication mode to use for an application of a plurality of applications that uses a data streaming platform to publish data of the application in a primary management container within a primary region of two or more geographic regions; and
replicate the data of the application captured from the primary management container within the primary region to a secondary management container within a secondary region of the two or more geographic regions using the data replication mode determined for the application.

2. The computing system of claim 1, wherein the data replication mode for the application comprises one of an inline replication mode or an on-demand replication mode.

3. The computing system of claim 1, wherein to determine the data replication mode for the application, the processing circuitry is configured to determine whether a recovery time for the primary management container provided by the on-demand replication mode satisfies a recovery objective for the application.

4. The computing system of claim 3, wherein the recovery time for the primary management container comprises a minimum amount of time required to load the data of the application from a storage account onto one or more partitions of the secondary management container within the secondary region.

5. The computing system of claim 3, wherein the processing circuitry is configured to determine the recovery time for the primary management container based on a number of partitions of the primary management container, a publication rate to each partition of the primary management container, a retention period for the primary management container, and a budgeted load time during failover from the primary management container within the primary region to the secondary management container within the secondary region.

6. The computing system of claim 3, wherein the processing circuitry is configured to, based on the recovery time for the primary management container satisfying the recovery objective for the application, determine that the data replication mode for the application comprises the on-demand replication mode.

7. The computing system of claim 3, wherein the processing circuitry is configured to, based on the recovery time for the primary management container not satisfying the recovery objective for the application, determine that the data replication mode for the application comprises an inline replication mode.

8. The computing system of claim 1, wherein to capture the data of the application from the primary management container, the processing circuitry is configured to:
collect data published to each partition of one or more partitions of the primary management container in one or more batches according to at least one of a batching time window or a batch size; and
store the batches for the one or more partitions as a plurality of data files in a storage account.

9. The computing system of claim 1, wherein the data of the application captured from one or more partitions of the primary management container is stored in batches for the one or more partitions as a plurality of data files in a storage account

10. The computing system of claim 9, wherein the data replication mode for the application comprises an inline replication mode, and wherein to replicate the data of the application, the processing circuitry is configured to:
continuously replicate the plurality of data files from the storage account to the secondary management container within the secondary region; and
continuously load the data from the batches included in the replicated data files onto one or more partitions of the secondary management container within the secondary region.

11. The computing system of claim 10, wherein the data of the application comprises data events and checkpoints, and wherein the processing circuitry is configured to:
maintain a mapping of sequence numbers of original data events within each partition of the primary management container to sequence numbers of replicated data events within each partition of the secondary management container; and
based on the mapping, determine which data event of the replicated data events is checkpointed for each partition of the secondary management container.

12. The computing system of claim 9, wherein the data replication mode for the application comprises an on-demand replication mode, and wherein to replicate the data of the application, the processing circuitry is configured to:
continuously replicate the plurality of data files from the storage account to the secondary management container within the secondary region;
based on a failover from the primary region to the secondary region being triggered, identify one or more batches included in the replicated data files to be loaded onto a partition of the secondary management container based on a retention period for the primary management container; and
load the data from the one or more batches included in the replicated data files onto one or more partitions of the secondary management container within the secondary region.

13. The computing system of claim 12, wherein the data of the application comprises data events and checkpoints, and wherein the processing circuitry is configured to:
extract a sequence number of a checkpoint for each partition of the primary management container; and
compare the sequence number of the checkpoint with an original sequence number of each replicated data event being loaded onto each partition of the secondary management container to determine which data event of the replicated data events is checkpointed for each partition of the secondary management container.

14. The computing system of claim 1, wherein the primary region is paired with the secondary region to manage replication of the primary management container, wherein, based on the pairing, the processing circuitry is configured to continuously replicate configuration information for the primary management container within the primary region to the secondary management container within the secondary region.

15. A method comprising:
determining, by a computing system, a data replication mode to use for an application of a plurality of applications that uses a data streaming platform to publish data of the application in a primary management container within a primary region of two or more geographic regions; and
replicating, by the computing system, the data of the application captured from the primary management container within the primary region to a secondary management container within a secondary region of the two or more geographic regions using the data replication mode determined for the application.

16. The method of claim 15, wherein determining the data replication mode for the application comprises determining whether a recovery time for the primary management container provided by the on-demand replication mode satisfies a recovery objective for the application.

17. The method of claim 15, wherein the data of the application captured from one or more partitions of the primary management container is stored in batches for the one or more partitions as a plurality of data files in a storage account

18. The method of claim 17, wherein the data replication mode for the application comprises an inline replication mode, and wherein replicating the data of the application comprises:
continuously replicating the plurality of data files from the storage account to the secondary management container within the secondary region; and
continuously loading the data from the batches included in the replicated data files onto one or more partitions of the secondary management container within the secondary region.

19. The method of claim 17, wherein the data replication mode for the application comprises an on-demand replication mode, and wherein replicating the data of the application comprises:
continuously replicating the plurality of data files from the storage account to the secondary management container within the secondary region;
based on a failover from the primary region to the secondary region being triggered, identifying one or more batches included in the replicated data files to be loaded onto one or more partitions of the secondary management container based on a retention period for the primary management container; and
loading the data from the identified one or more batches included in the replicated data files onto the one or more partitions of the secondary management container within the secondary region.

20. Computer-readable media storing instructions that, when executed, cause one or more processors to:
determine a data replication mode to use for an application of a plurality of applications that uses a data streaming platform to publish data of the application in a primary management container within a primary region of two or more geographic regions; and
replicate the data of the application captured from the primary management container within the primary region to a secondary management container within a secondary region of the two or more geographic regions using the data replication mode determined for the application.
